(19) United States
(12) Patent Application Publication
(10) Pub. No.: US 2023/0365229 A1
(43) Pub. Date: Nov. 16, 2023

(54) AN AIR SUPPLY SYSTEM FOR A HULL OF A VESSEL AND A VESSEL COMPRISING THE AIR SUPPLY SYSTEM

(71) Applicant: MAERSK A/S, Copenhagen K (DK)

(72) Inventor: Mikkel PREEM, Ballerup (DK)

(21) Appl. No.: 18/028,476

(22) PCT Filed: Sep. 27, 2021
(86) PCT No.: PCT/EP2021/076452

§ 371 Date: Mar. 24, 2023

(30) Foreign Application Priority Data
Sep. 28, 2020 (DK) PA202070657

(51) Int. Cl. B63B 1/38

(52) U.S. Cl. CPC B63B 1/38; B63B 2001/385; B63B 2001/387

(57) ABSTRACT

Disclosed is an air supply system (100) for supplying air to an outside of a hull of a vessel. The air supply system (100) comprises a plurality of air discharge units, ADUs, (20) for releasing a compressed air flow to the outside of the hull below a waterline of the vessel, wherein the plurality of ADUs (20) are configured to be arranged around a longitudinal centre line (202) of the hull of the vessel. The air supply system (100) comprises a first flow path (11A) for providing the compressed air flow to the ADUs (20). The air supply system (100) comprises one or more pressure control device(s) (30) arranged in the first flow path (11A) for feeding the compressed air flow to the ADUs (20) at pressure larger than a discharge pressure at the ADUs (20). Each pressure control device (30) comprises an inlet (34) for receiving an inlet air flow, a first outlet (35A) and a second outlet (35B) for feeding the air flow to a subset of the plurality of ADUs (20AB, 20BA; 20CD, 20DC). The first outlet (35A) is connected to a first subset of ADUs (20AB; 20CD) arranged on a first side of the longitudinal centre line (202) of the hull (201) of the vessel (200) and the second outlet (35B) is connected to a second subset of ADUs (20BA; 20DC) arranged on a second, opposite, side of the longitudinal centre line (202) of the hull of the vessel. The one or more pressure control device(s) (30) is/are configured to compensate for a difference in discharge pressure between the first subset of ADUs (20AB; 20CD) and the second subset of ADUs (20BA; 20DC).

The present disclosure pertains to the field of propulsion of vessels. The present disclosure relates to an air supply system for supplying air to an outside of a hull of a vessel and a vessel comprising the air supply system.

### BACKGROUND

A vessel's resistance when moving through water is made up of multiple components, of which frictional resistance is the most dominant. Injection of an air flow into a turbulent boundary layer around the hull of the vessel may be used to reduce the frictional resistance of the hull of the vessel in the water. The turbulent boundary layer is located between stationary water and the moving water close to the hull of the vessel.

Air lubrication of the hull can reduce the frictional loss significantly. Depending on the type of propulsion used for the vessel, an efficiency of the vessel may be drastically improved. The efficiency gain is dependent on speed, hull form, draft of the vessel and/or a distribution and amount of air to a wetted surface of the vessel. The draft of the vessel is the vertical distance from the bottom of a keel of the vessel to the waterline and the wetted surface is the total area of the vessels outer surface in contact with the surrounding water.

The total net efficiency improvement depends on the power used to pressurize the air flow required to reduce the friction. Hence, a net propulsion efficiency is dependent on the power required to facilitate the air flow and a given discharge pressure at an air outlet in the hull. The discharge pressure corresponds to the water pressure from the water surrounding the vessel acting on the air outlet ports.

When the vessel rolls in the water, such as when the vessel rotates along a longitudinal centreline and is not level, the discharge pressure may vary over the outlet ports due to the water level acting on each of the air outlet ports varying. The air outlet ports being submerged deeper into the water while the vessel is rolling will experience a higher discharge pressure, since more water needs to be discharged from the air outlet ports, while the air outlet ports moving upwards in the water will experience a lower discharge pressure, since less water needs to be discharged from the air outlet ports. This may lead to uneven or interrupted air discharge from some air outlet ports.

### SUMMARY

Accordingly, there is a need for an air supply system for supplying air to an outside of a hull of a vessel, which mitigates, alleviates or addresses the shortcomings existing and provides a more efficient air supply system.

The pressure of the air supplied to the air outlet ports is to be controlled to ensure that the flow of air to the air outlet ports is not interrupted when the discharge pressure at one or more air outlet ports increases. Known solutions for controlling the pressure of the air flow to the air outlet ports are complicated, costly and require a large amount of processing power to operate, there is a need for a simpler solution to control air flow to avoid the problem of uneven or interrupted air discharge.

Disclosed is an air supply system for supplying air to an outside of a hull of a vessel. The air supply system comprises a plurality of air discharge units (ADUs) for releasing a compressed air flow to an outside of the hull below a waterline of the vessel. The plurality of ADUs are configured to be arranged around a longitudinal centreline of the hull of the vessel. The air supply system comprises a first flow path for providing the compressed air flow from the engine to the ADUs. The air supply system comprises one or more pressure control device(s) arranged in the first flow path for feeding the compressed air flow to the ADUs at pressure larger than a discharge pressure at the ADUs. Each pressure control device comprises an inlet for receiving an inlet air flow, a first outlet and a second outlet for feeding the compressed air flow to a subset of the plurality of ADUs. The first outlet is connected to a first subset of ADUs arranged on a first side of the longitudinal centreline of the hull of the vessel and the second outlet is connected to a second subset of ADUs arranged on a second, opposite, side of the longitudinal centreline of the hull of the vessel. The one or more pressure control device(s) is/are configured to compensate for a difference in discharge pressure between the first subset of ADUs and the second subset of ADUs.

It is an advantage of the air supply system of the present disclosure that the air supply system will provide an even distribution of the compressed air across the hull of the vessel, such as across a beam of the vessel, the beam being the widest part of the vessel from one side to the other. By supplying ADUs arranged at opposite sides of the hull with a compressed air flow from different outlets of the same pressure control device, the flow of compressed air to the ADUs will be equal but the pressure of the compressed air flow may vary dependent on an the discharge pressure at the ADUs, e.g. due to an inclination angle of the vessel. It is an advantage that the air supply system provided herein ensures a fixed flow control of air to the ADUs, without the need of throttles or valves for controlling the flow of compressed air to the ADUs. The air supply system thus provides a passive solution for controlling the distribution of air to the ADUs during rolling of the vessel.

Disclosed is a vessel comprising a hull, an engine and the air supply system according to the present disclosure.

It is an advantage of the present disclosure that the vessel comprising the air supply system will have an even distribution of compressed air across the hull of the vessel, such as across a beam of the vessel. By supplying ADUs arranged at opposite sides of the hull with a compressed air flow from different outlets of the same pressure control device, the flow of compressed air to the ADUs will be equal but the pressure of the compressed air flow may vary dependent on an the discharge pressure at the ADUs, e.g. due to an inclination angle of the vessel. It is an advantage that the air supply system provided herein ensures a fixed flow control of air to the ADUs, without the need of throttle or valves for controlling the flow of compressed air. The vessel according to this disclosure thus provides a passive solution for controlling the distribution of air to the ADUs during rolling of the vessel.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 illustrates a known air supply system,

FIG. 2 illustrates an example air supply system according to this disclosure,

FIG. 3 illustrates an example air supply system according to this disclosure,

FIG. 4 illustrates the control of an example air supply system for a level vessel according to this disclosure,

FIG. 5 illustrates the control of an example air supply system for a rolling vessel according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

During rolling of a vessel, such as when the vessel rotates around its longitudinal centreline, the discharge pressure at the ADUs may vary over the ADUs depending on how deep the ADUs are submerged in the water surrounding the vessel. During rolling of the vessel the depth of the ADUs in the water may depend on the distance of the ADUs from the longitudinal centre line of the vessel. An ADU arranged further away from the longitudinal centreline of the vessel will be submerged deeper in the water or lifted higher out of the water when the vessel is rolling around the longitudinal centreline. If the vessel is rolling along the longitudinal centerline of the vessel, an ADU arranged on the port side diffusor may experience increased discharge pressure when the vessel is leaning towards the port side, such as when the port side is closer to the water. The discharge pressure may comprise a static part P and a dynamic part dP. The discharge pressure for the ADU arranged on the port side (PS) may thus be P+dP(PS). However, an opposite ADU located at the same distance to the rotation axis on the starboard (SB) side of the vessel, such as to the longitudinal centreline of the vessel, the pressure for this ADU may be P+dP(SB). In this case, where the ADUs are located at the same distance from the longitudinal centreline of the vessel, dP(SB)=−dP(PS). The dynamic pressure will thus decrease on the starboard side with the same amount as the dynamic pressure increases on the port side of the vessel. The same phenomenon will occur as the vessel rolls to the other side in a roll period. The static part P of the discharge pressure comprises the hydrostatic pressure P(draft) at the ADU with no inclination, such as when the vessel is level, and the pressure loss P(loss) in the air supply system upstream of the ADUs. The dynamic part of the pressure is due to the movement, such as the rolling, of the vessel. When the vessel operates at high seas with high inclination angles, the dynamic part of the pressure will be higher than when the vessel is operating at low seas with low inclination angles.

An air supply system for supplying air to an outside of a hull of a vessel is disclosed herein. The air supply system comprises a plurality of ADUs for releasing a compressed air flow to an outside of the hull below a waterline of the vessel. The plurality of ADUs are configured to be arranged, such as symmetrically or at least substantially symmetrically arranged, around a longitudinal centreline of the hull of the vessel, so that the compressed air is evenly distributed along the hull of the vessel. The air supply system comprises a first flow path for providing the compressed air flow to the ADUs. The air supply system comprises one or more pressure control device(s) arranged in the first flow path for feeding the compressed air flow to the ADUs at pressure larger than the discharge pressure at the ADUs. Each pressure control device comprises an inlet for receiving an inlet air flow, and a plurality of outlets, such as a first outlet and a second outlet, for feeding the compressed air flow to a subset of the plurality of ADUs, such as to a respective subset of ADUs. The first outlet is connected to a first subset of ADUs arranged on a first side, such as on a port side, of the longitudinal centreline of the hull of the vessel. The second outlet is connected to a second subset of ADUs arranged on a second, opposite, side, such as on a starboard side, of the longitudinal centreline of the hull of the vessel.

In one or more example air supply systems, the one or more pressure control device(s) may be fixed volume displacement pressure control devices. The pressure control device(s) may be arranged in the first flow path for feeding the compressed air flow to the ADUs with a fixed volume displacement and at pressure larger than a discharge pressure at the ADUs. Having a fixed volume displacement pressure control device has the benefit that the pressure control device will always provide a fixed flow of compressed air to the first and second outlet irrespective of the pressure of the flow to each of the first and/or second outlets. If the discharge pressure acting against the flow of compressed air from the pressure control device increases the pressure control device will ensure the fixed flow by creating an increased pressure of the flow of compressed air.

In one or more example air supply systems, the inlet air flow may be ambient air, such as air at atmospheric pressure. The ambient air may be fed to the first pressure control device and the second pressure control device, where the air may be compressed to a pressure larger than the discharge pressure at the ADUs. The compressed air is then supplied to the ADUs via the first and the second outlets of the first and the second pressure control device. Using ambient air as inlet air flow has the benefit that the air supply system is easy to implement in a vessel and may be used as a stand-alone system for controlling the flow of compressed air to the ADUs. Furthermore, using ambient air reduces the requirement of cooling the air before providing the air to the first flow path. Thus, the risk of corrosion in the air supply system due to condensation of the air provided to the air supply system is reduce.

In one or more example air supply systems, the inlet air flow may be a compressed scavenging air flow from an engine of the vessel. Using scavenging air as the inlet air flow has the benefit that the inlet air flow has already been compressed, thereby reducing the required compression ratio of the pressure control device for providing a flow of compressed air having a pressure above the discharge pressure at the ADUs: Thereby, simpler and more cost-efficient pressure control devices, such as blowers or compressors, may be used.

In some example air supply systems disclosed herein, the pressure control device may comprise more than two outlets, such as three, four, five or even more outlets, for feeding the compressed air flow to a subset of the plurality of ADUs, such as to a respective subset of ADUs. In some example air supply systems disclosed herein, the one or more pressure control devices may comprise as many outlets as the number of ADUs comprised in the air supply system divide by the number of pressure control devices. Thereby, an individual control of the flow to each ADU may be provided. For example, if the air supply system comprises one pressure control device and ten ADUs, the pressure control device may comprise a maximum of ten outlet ports for supplying each ADU individually. If the air supply system comprises more than one pressure control device, each pressure control device may comprise for example five outlets for supplying a subset of the ADUs individually when the ADUs are evenly distributed between the pressure control devices. However, the ADUs may in one or more example air supply systems also be unevenly distributed, so that a first pressure control device supplies compressed air to for example four out of ten ADUs and a second pressure control device supplies compressed air to the remaining six out of the ten ADUs. In this example scenario, the first pressure control device may comprise a maximum of four outlets connected to an individual ADU while the second pressure control device may comprise a maximum of six outlets connected to an individual ADU. The number of outlet ports on the pressure control unit may however also be less than the number of ADUs supplied by the pressure control device, since one outlet may supply a plurality of ADUs with compressed air. By supplying more than one ADUs with compressed air from the same outlet, the cost and complexity of the air supply system may be reduced.

In some example air supply systems herein, the first subset of ADUs may be arranged at a same distance from the longitudinal centreline of the vessel as the second subset of ADUs. The first outlet and the second outlet of the one or more pressure control devices may thus be connected to respective subsets of ADUs arranged at equal distance from, but on opposite sides of, the longitudinal centreline of the hull of the vessel. By arranging the first subset of ADUs at a same distance from the longitudinal centreline of the vessel as the second subset of ADUs, the dynamic pressures, such as the pressure change, at the first and second set of ADUs will cancel each other out during rolling of the vessel. The dynamic pressures cancelling each other out means that the dynamic pressure at the first subset of ADUs will increase with the same amount as the dynamic pressure at the second subset of ADUs decreases when the vessel rolls around its longitudinal centreline, and vice versa. Thus, the pressure increase at the first outlet of the pressure control device will be equal to the pressure decrease at the second outlet of the pressure control device, and vice versa.

In some example air supply systems herein, each pressure control device may comprise a drive unit, and one or more pressure boosting unit(s) for feeding the compressed air to the first and/or the second outlet of the pressure control device. In some example air supply systems herein, the pressure control device may comprise a plurality of pressure boosting units, such as a first pressure boosting unit for feeding compressed air to the first outlet and a second pressure boosting unit for feeding compressed air to the second outlet. The first pressure boosting unit and the second pressure boosting unit may be driven by the same drive unit, so that they are synchronously driven an provide the same air flow. When the vessel rolls around its longitudinal centreline such that the dynamic pressure at the ADUs varies, the pressure that has to be provided by each of the plurality of pressure boosting units is depending on the dynamic part of the discharge pressure at the ADUs connected to the corresponding outlets of the pressure boosting units. If the pressure control device comprises a first and a second pressure boosting unit and the first and second pressure boosting units are connected to respective ADUs arranged at a same distance on opposite sides of the longitudinal centreline of the vessel, the first and the second pressure boosting units will experience opposite dynamic discharge pressures when the vessel is rolling. Experiencing opposite dynamic discharge pressures means that the first pressure boosting unit experiences an increase in discharge pressure with the same amount as the second pressure boosting unit experiences a decrease in discharge pressure, and vice versa. To ensure the fixed volume flow to the ADUs, the first pressure boosting unit thus has to increase the pressure of the flow of compressed air to overcome the increased discharge pressure. At the same time, the second pressure boosting unit may decrease the pressure of the flow of compressed air to overcome the decreased discharge pressure. The increased power requirement experienced by the drive unit for increasing the pressure at the first pressure boosting unit thus corresponds to the reduced power requirement from the second pressure boosting unit, and the changes in power requirements from the first and the second pressure boosting units thus cancel each other out. Correspondingly, the difference in discharge pressures between the ADUs arranged on opposite sides of the longitudinal centreline of the vessel can be compensated without a change in power requirement experienced by the drive unit of the pressure control device. In some example air supply systems disclosed herein, one pressure boosting unit may feed compressed air to all outlets of the pressure control device, such as to the first and the second outlet. The compressed air flow provided to the plurality of outlets, such as to the first and second outlet may thus be the same. The plurality of pressure boosting units, such as the first pressure boosting unit and/or the second pressure boosting unit may be a blower or a compressor, such as a fixed volume displacement blower or compressor. In some example air supply systems, the first pressure boosting unit and/or the second pressure boosting unit may be one or more Roots blower(s) or piston type compressors. The blower may be a simpler pressure boosting means than the compressor but may operate at a lower pressure ratio than the compressor, such as for example a ratio of 1.1 to 1.2 for the blower compared to a ratio greater than 1.2 for the compressor, or higher depending on the configuration of the compressor. The Roots blower comprises two rotary vanes configured to mesh with each other upon rotation. Each rotary vane is arranged on an individual axle, wherein the individual axles are connected to each other via gears so that the axles may be driven synchronously by a single drive unit. Each of the rotary vanes may according to this disclosure be considered as being a pressure boosting unit. The Roots compressor may thus be considered comprising a drive unit, and a first and a second pressure boosting unit.

In one or more example pressure control devices the first pressure boosting unit and the second pressure boosting unit, may be driven by the drive unit via a common shaft or via a gear system. In one or more example air supply systems, the first pressure boosting unit and the second pressure boosting unit may however also be individually driven pressure boosting units being synchronously controlled to provide the same flow. The drive unit may be an electric motor. By running the one or more pressure boosting units synchronously, such as by connecting them to the same drive unit, such as via a common shaft, the one or more pressure boosting units will give the same volume flow in the two outlets of the pressure control device, presuming that the pressure boosting units are identical in shape and size. The flow through the plurality of outlets may thereby be equal but the pressure of the compressed flow of air may be different and may depend on the discharge pressure at the ADUs. The discharge pressure may depend on the rolling, such as on the inclination angle, of the vessel. When the discharge pressure in one or more of the ADUs arranged on the port side increases, the pressure required at the first pressure boosting unit to provide the fixed volume flow increases. This will increase the power requirement on the drive unit from the first pressure boosting unit. However, since the discharge pressure at the starboard side ADUs simultaneously, such as at the same time, will decrease with the same amount, so will the power requirement on the drive unit from the second boosting unit. The drive unit will thus not experience any net changes, or at least not any substantial net changes, in power demand from the first and the second pressure boosting units. Hence, the one or more pressure control devices will passively adapt the pressure at the first outlet and the second outlet, such as at the first pressure boosting unit and the second pressure boosting unit, passively.

In one or more example air supply systems disclosed herein, the air supply system may comprise one or more turbochargers. Each turbocharger comprises a turbine driven by an exhaust gas flow from the engine of the vessel. The turbine may comprise a turbine housing and a turbine wheel rotatably arranged in a turbine housing. The turbine wheel may be forced to rotate by an exhaust gas flow through the turbine housing. The exhaust gas flow may be received from an exhaust gas receiver of the engine. The exhaust gas receiver may receive exhaust gases produced during a combustion process from the engine. Each turbocharger further comprises a compressor for supplying the compressed scavenging air flow to the engine, such as to a scavenging air receiver of the engine, via the first flow path. The compressor may comprise a compressor housing and a compressor wheel, which may also be referred to as an impeller, rotatably arranged within the compressor housing. The compressor wheel may be rigidly connected to the turbine wheel so that the turbine wheel drives the compressor wheel. The compressor receives air which is then compressed by the rotation of the compressor wheel. The compressed air from the compressor of the turbocharger, which compressed air may also be referred to as scavenging air, may then be fed to the engine, such as to the scavenging air receiver of the engine via a scavenging air flow path. The scavenging flow path may comprise an air cooler for cooling the compressed air from the compressor of each turbocharger, a water mist catcher for removing moisture from the compressed air flow, and/or a non-return valve for preventing air to flow from the scavenging air receiver into the scavenging air flow path. The water mist catcher may be arranged downstream of the air cooler. The non-return valve may be arranged downstream of the water mist catcher. In one or more example air supply systems the first flow path may be connected to the scavenging air flow path for extracting the scavenging air flow. The first flow path may be connected to the scavenging air flow path between the air cooler and the water mist catcher. Extracting the scavenging air downstream the air cooler has the benefit that the extracted scavenging air is cooled. Cooling the air reduces risk of corrosion in the air supply system, which reduces the required maintenance of the system. Cooling the air further allows a higher density flow, which increases the energy efficiency of the system. Extracting the scavenging air upstream the water mist catcher prevents contaminated gases from the combustion process to leak into the first flow path. Thus, only non-contaminated, such as clean, air is provided to the outside of the hull of the vessel, which may reduce the environmental impact of the air supply system. In some example air supply systems, the first flow path may be connected to the scavenging air flow path downstream the water mist catcher. Thereby, condensation generated by the cooling of the scavenging air may be removed from the scavenging air before it is provided to the pressure control device in the first flow path. This may reduce the risk of damage to the pressure control device caused by condensation remaining in the pressure control device. When the first flow path is connected to the scavenging air path downstream the water mist catcher, the scavenging air path may comprise a non-return valve arranged downstream of the connection point between the first flow path and the scavenging air path, to prevent contaminated gases from the combustion process to leak into the first flow path from the scavenging air receiver. The air supply system may comprise a changeover valve arranged in the first flow path for opening and/or closing the first flow path, in order to allow or prevent a flow of air, such as scavenging air through the first flow path.

In some example air supply systems, the pressure control device and/or the pressure boosting units may comprise drain or a deflector plate for draining condensation water from the pressure control device and/or the pressure boosting units. Thereby, the risk of the pressure control device and/or the pressure boosting units failing due to moisture may be reduced.

The pressure of the compressed scavenging air flow may be dependent on the load of the engine. At low loads the exhaust gas flow may be low which will cause the turbine of the turbocharger, which is driven by the exhaust gas flow, to rotate at low revolutions per minute (rpm). Consequently, the compressor of the turbocharger will rotate at the same rpm and will not provide its maximum compression performance. At low engine loads, the scavenging pressure may thus be below the discharge pressure at the ADUs. The scavenging air may thus be fed to the one or more pressure control devices, where the pressure of the scavenging air flow is boosted, such as increased, to a pressure larger than the discharge pressure at the ADUs. The scavenging air flow having a pressure larger than the discharge pressure at the ADUs is then fed to the ADUs where it is discharged to the outside of the hull of the vessel. Using scavenging air flow as the inlet air flow has the benefit that the inlet air flow has already been compressed, such as pre-compressed, by the one or more turbochargers. The pressure control device thus has to perform less compression work compared to the one or more example air supply systems where the inlet air flow is ambient air. When the inlet air flow has been pre-compressed a blower or a compressor having a lower compression ratio may be used as pressure boosting unit, since the compression work that has to be performed by the pressure control device is lower.

Upon the pressure of the compressed air flow upstream of the pressure control device exceeding the discharge pressure at the ADUs, such as at higher engine loads where the pressure of the scavenging air is larger than the discharge pressure, the first pressure boosting unit and/or the second pressure boosting unit may be configured to reduce the flow through the first flow path. Reducing the flow through the first flow path may be done to ensure sufficient flow of compressed air, such as scavenging air, to the engine. In case the flow of compressed air through the first flow path is too high, such that most of the air flows to the ADUs and not through the engine combustion chamber, the engine of the vessel may overheat. By reducing the flow through the first flow path it can be ensured that the engine receives the air required for cooling and combusting the fuel in the combustion chamber. The first pressure boosting unit and/or the second pressure boosting unit may e.g. windmill in the air flow through the first flow path. The first pressure boosting unit and/or the second pressure boosting unit may thus act as restrictors in the first flow path. The pressure control device may be controlled to allow a target flow through the first flow path, such as by boosting the pressure when the flow of air received by the pressure control device is below the target flow or by restricting the flow of air when the flow of air received by the pressure control device is above the target flow. The flow through the pressure control device may be controlled based on an engine load and/or a maximum allowed bypass flow at that given engine load.

In some example air supply systems herein, the drive unit may, upon the pressure of the compressed air flow upstream of the pressure control device exceeding the discharge pressure at the ADUs, be configured to be driven by the first pressure boosting unit and/or the second pressure boosting unit and to remove energy from the flow of air. When the drive unit is an electric motor, the electric motor may be configured to, upon the pressure of the compressed air flow upstream of the pressure control device exceeding the discharge pressure at the ADUs, be driven by the first pressure boosting unit and/or the second pressure boosting unit and to act as a generator of electrical energy. The electrical energy generated may be fed to an electrical system of the vessel or to an energy storage. The electrical energy generated may be used for driving the pressure control unit when the pressure and/or the flow of compressed air has to be increased.

In one or more example air supply systems, the air supply system may comprise two or more turbochargers. The air supply system may further comprise one or more cut-out valves for turning on or off a gas flow to a turbine side and/or from a compressor side of at least one of the two or more turbochargers. By turning off an exhaust gas flow to the turbine side of the at least one of the turbochargers by closing the cut-out valves a larger flow of exhaust gas may be provided to the remaining turbochargers, thereby increasing their compressing capacity, which will increase the pressure generated by the active turbocharger(s).

In one or more example air supply systems, the engine efficiency may be improved by using a turbocharger cut-out (TCCO) to increase the pressure of the air flow from the one or more turbocharger to the main flow path of the engine. If for example the engine is aspirated using a plurality of turbochargers, such as two or more turbochargers, one of the plurality of turbochargers may be cut-out, for example by disconnecting at least a first turbocharger of the plurality of turbochargers from an exhaust gas inlet of the turbine of the turbocharger and/or from an compressed air outlet from the compressor of the turbocharger. This will allow all of the air, such as all of the exhaust gas and/or all of the ambient air supplied to the engine, to flow through one or more second of the plurality of turbochargers, which may also be referred to as one or more active turbocharger(s). Since the available exhaust gas flow has to drive a smaller number of turbochargers, the exhaust gas flow to each of the active turbochargers, such as the turbochargers that have not been cut-out, will increase. The increase in exhaust gas to the one or more active turbochargers will cause them to spin faster which will increase the pressure of the compressed air from the compressor side of these turbochargers through the main flow path. The higher exhaust gas pressure to the one or more active turbocharger(s) will increase the turbocharger efficiency and may thus allow a higher air pressure to flow through the main flow path to the engine, compared to a scenario where all of the turbochargers are active. The scenario where all of the turbochargers are active may herein also be referred to a normal operation or normal operating condition.

In one or more example air supply systems, the air supply system may comprise a flow control device arranged in the first flow path for controlling the flow through the first flow path. The flow control device may be a fixed orifice allowing a fixed flow through the first flow path, or a variable orifice, such as a control valve, for allowing a variable flow of air through the first flow path. The flow control device may be controlled based on the engine load and/or a maximum allowed bypass flow at that given engine load.

In one or more example air supply systems, the air supply system may comprise one or more non-return valves arranged in the first flow path between the one or more pressure control device(s) and the ADUs for preventing sea water from entering the first flow path through the ADUs.

When the vessel is rolling, such as when the vessel is located at an inclination angle to the water surface, the discharge pressure may vary over the ADUs depending on their relative distance from the centreline of the hull. The ADUs being arranged on the opposite side to which the vessel is rolling towards, such as the ADUs on the starboard side when the vessel is rolling towards the port side and vice versa, will be submerged less deep into the water than the ADUs on the port side.

The water pressure acting on the ADUs on the starboard side will thus be lower than the water pressure acting on the port side. Each pair of ADUs equidistant, such as arranged at the same distance, from the longitudinal centreline on either side of the vessel, such as on a port and a starboard side of the vessel, will experience an equal plus/minus delta of pressure. The delta of pressure means the change of the pressure. The actual delta pressure will be different for ADU pairs arranged at a different distance from the longitudinal centre line, such as more inwards or outwards athwartships from the centreline. The one or more pressure control device(s) may provide a fixed volume flow of air to each the plurality of ADUs, however the pressure provided through the outlet connected to ADUs arranged on the port side of the vessel will provide a higher pressure to each the plurality of ADUs, than the pressure provide by the second outlet connected to the starboard side ADUs. The second pressure control device that is connected to the ADUs mounted closer to the centreline if the vessel will provide a lower pressure to the ADUs at constant flow, since the pressure difference between the port and the starboard side ADUs will be less than for the ADUs mounted further away from the centreline, such as at a transverse position further away from the centreline of the vessel, and thus will experience less vertical movement than the ADUs. Thereby, the pressure difference due to the difference in water level acting on the ADUs on either side of the longitudinal centreline will also be less.

The distribution of air to the ADUs dependent on the discharge pressure at the ADUs, such as dependent on the inclination angle of the vessel, may with the air supply system disclosed herein be controlled without using control valves, such as throttle valves, for controlling the air flow to the different ADUs.

Although the example air supply systems disclosed herein are described as compensating for discharge pressure differences between ADUs arranged on opposite sides of the longitudinal centreline of the vessel, the air supply system may also be configured to compensate for pressure differences at ADUs arranged on opposite sides of a lateral centreline of the hull of the vessel. The air supply system may thus compensate for discharge pressure differences at the ADUs due to trim and/or pitching of the vessel. The first outlet of the pressure control device may be connected to a first subset of ADUs arranged on a first side of the lateral centreline of the hull of the vessel. The second outlet may be connected to a second subset of ADUs arranged on a second, opposite, side of the lateral centreline of the hull of the vessel. By connecting the ADUs arranged on a first side of the vessel to a first outlet of the one or more pressure control device(s) and the ADUs arranged on a second side of the vessel to a second outlet of the one or more pressure control device(s), the one or more pressure control device(s) is/are configured to compensate for a difference in discharge pressure between the first subset of ADUs and the second subset of ADUs.

A vessel comprising a hull and the air supply system according to any one of the examples provided herein is further disclosed. The vessel may further comprise an engine, such as a main engine, for propelling the vessel.

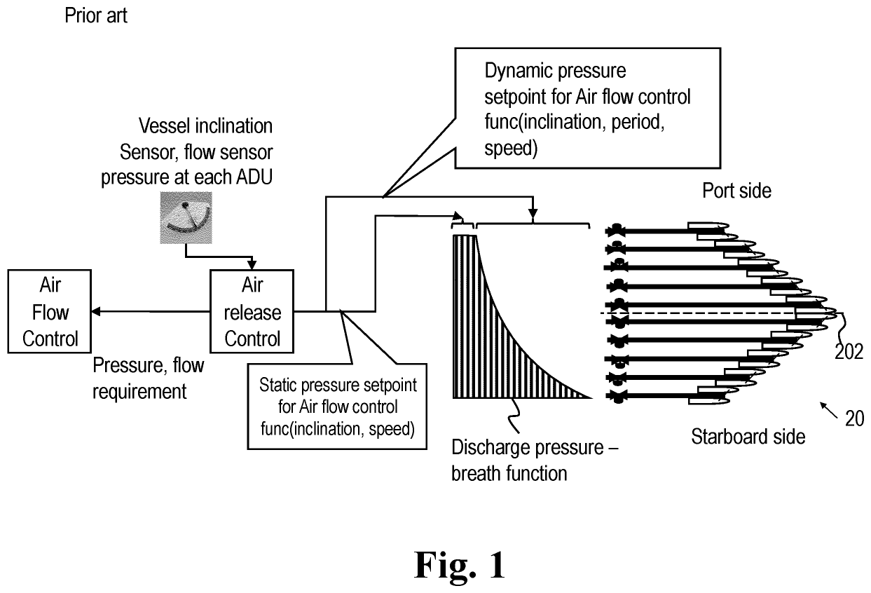

FIG. 1 illustrates an example of a known solution for controlling an air supply system during rolling of the vessel. During rolling of a vessel, such as when the vessel rotates around its longitudinal centreline, the discharge pressure at the ADUs may vary over the ADUs depending on how deep the ADUs are submerged in the water surrounding the vessel. If the vessel is rolling along a longitudinal centerline of the vessel, an ADU arranged on the port side diffusor may experience increased discharge pressure when the vessel is leaning towards the port side, such as when the port side is closer to the water.

In order to compensate for the changing pressure at the ADUs 20 during rolling of the vessel, known solution typically use individual control valves, such as throttle valves, for controlling the flow to each ADU 20 individually. The control valves may be controlled by an air release control unit based on an inclination of the vessel, a flow of air to the ADUs and/or a pressure sensor arranged at each of the ADUs. The air release control unit may set a static pressure setpoint for the air flow control based on the inclination and the speed of the vessel, and a dynamic setpoint based on the inclination, a periodicity of the rolling and the speed of the vessel. The static pressure may be constant for all of the ADUs 20 while the dynamic setpoint may vary with the rolling of the vessel. In the scenario shown in FIG. 1 the vessel rolls towards a starboard side of the vessel. As can be seen in FIG. 1, the discharge pressure of the starboard side ADUs 20 thereby increases while the discharge pressure at the ADUs at the port side of the vessel reduces until it reaches the static pressure setpoint. In order to ensure a flow to all of the ADUs 20, the individual control valves may be operated to increase the pressure of the air flow to the ADUs 20 individually, so that the pressure of the air flow to the ADUs at the starboard side of the vessel is increased until it overcomes the discharge pressure, while the pressure at the port side ADUs may be reduced. This system is thus very complex and requires a lot of information from sensors, such as inclination sensors, flow sensors, speed sensors, pressure sensors and or draft pressure sensors to continuously adapt the pressure to the current operating conditions of the vessel. The know systems thus use an active control of the valves to ensure an equal flow of air over the hull, such as a beam of the vessel. The beam of the vessel is the widest part of the vessel from one side to the other

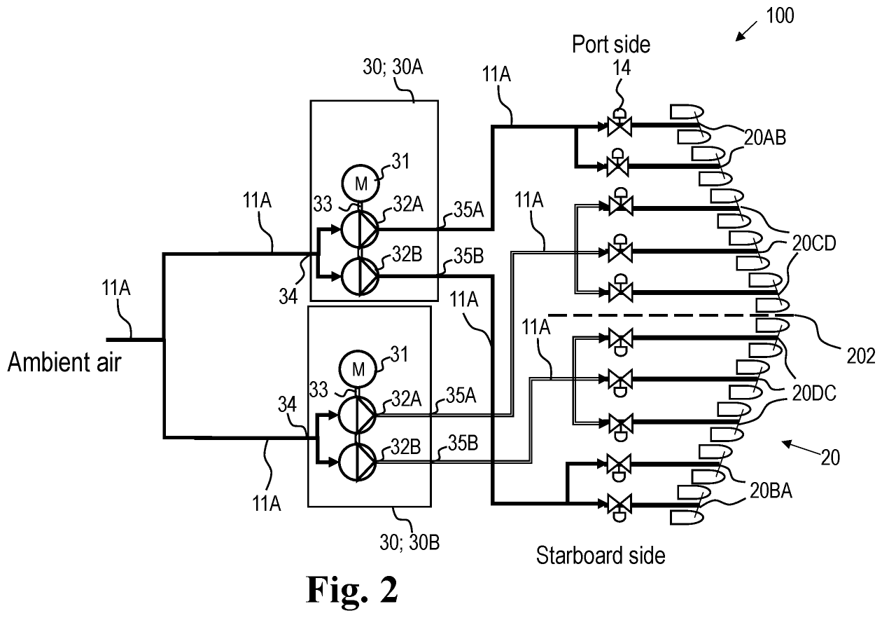

FIG. 2 illustrates an example air supply system 100 for supplying air to an outside of the hull of the vessel according to the current disclosure. The air supply system 100 comprises a plurality of ADUs 20 for releasing a compressed air flow to an outside of the hull below a waterline of the vessel. The ADUs 20 may be openings in the hull of the vessel through which openings air can escape to the outside of the hull. The plurality of ADUs 20 are configured to be arranged around a longitudinal centreline 202 of the hull of the vessel. The ADUs 20 may be symmetrically arranged, or at least substantially symmetrically arranged around the longitudinal centreline of the vessel. Being substantially symmetrically arranged around the longitudinal centreline means that the location of the ADUs on the hull of the vessel, may differ slightly between the first and the second side, such as the port and starboard side of the vessel. The plurality of ADUs are arranged to provide an equal flow over the hull of the vessel, such as over the beam of the vessel. The air supply system comprises a first flow path 11A for providing the compressed air flow to the ADUs 20. The example air supply system 100 shown in FIG. 2 further comprises two pressure control device(s) 30, such as a first pressure control device 30A and a second pressure control device 30B, arranged in the first flow path 11A for feeding the compressed air flow to the ADUs 20 at pressure larger than a discharge pressure at the ADUs 20. Each pressure control device 30 comprises an inlet 34 for receiving an inlet air flow, a first outlet 35A for feeding the air flow to a subset 20AB or 20CD of the plurality of ADUs 20, and a second outlet 35B for feeding the air flow to a subset 20BA or 20DC of the plurality of ADUs 20. The pressure control devices 30 may be configured to control the pressure and/or the flow of the air passing through the pressure control devices 30, such as increase and/or decrease the pressure and/or the flow of the air. The pressure control devices 30 may be fixed volume displacement pressure control devices. The pressure control devices 30 may be configured to provide a fixed volume flow at a given speed of the pressure control device 30. The first outlet 35A of the first pressure control device 30A is connected to a first subset of ADUs 20AB arranged on a first side of the longitudinal centreline 202 of the hull 201 of the vessel 200, such as on a port side of the vessel. The second outlet 35B of the first pressure control device 30A is connected to a second subset of ADUs 20BA arranged on a second, opposite, side of the longitudinal centreline 202 of the hull of the vessel, such as to a starboard side of the vessel. The first outlet 35A of the second pressure control device 30B is connected to a third subset of ADUs 20CD arranged on the first side of the longitudinal centreline 202 of the hull 201 of the vessel 200. The third subset of ADUs 20CD may be arranged closer to the centreline of the hull than the first subset of ADUs 20AB. The second outlet 35B of the second pressure control device 30B is connected to a fourth subset of ADUs 20DC arranged on the second, opposite, side of the longitudinal centreline 202 of the hull of the vessel. The first subset of ADUs 20AB may be arranged at the same distance from the longitudinal centreline 202 of the vessel as the second subset of ADUs 20BA, so that the first outlet 35A and the second outlet 35B are connected to respective subsets of ADUs 20AB, 20BA arranged at equal distance from but on opposite sides of the longitudinal centreline 202. Correspondingly the third subset of ADUs 20CD may be arranged at a same distance from the longitudinal centreline 202 of the vessel as the fourth subset of ADUs 20DC. In other words, the ADUs 20AB and 20BA, and 20CD and 20DC, may be mirrored around the longitudinal centreline 202. The first outlet 35A and the second outlet 35B of the first pressure control device 30A and the second pressure control device 30B are thus configured to provide a flow of compressed air to corresponding subsets of ADUs 20AB, 20BA; 20CD, 20DC on opposite sides of the centreline 202 of the hull of the vessel.

In the example air supply system 100 shown in FIG. 2, each pressure control device 30; 30A, 30B comprises a drive unit 31, a first pressure boosting unit 32A for feeding compressed air to the first outlet 35A and/or a second pressure boosting unit 32B for feeding compressed air to the second outlet 35B. The first pressure boosting unit 32A and the second pressure boosting unit 32B may be synchronously driven, such as driven by the same drive unit 31. The drive unit 31 may be an electric motor. The first pressure boosting unit 32A and/or the second pressure boosting unit 32B may for example be a blower or a compressor, such as a fixed volume displacement blower or compressor. The fixed volume displacement blower is configured to provide a predetermined flow of air at a predetermined speed, such as revolutions per minute (rpm) of the pressure boosting means. In some example air supply systems 100, the first pressure boosting unit 32A and/or the second pressure boosting unit 32B may be one or more Roots blower(s). The Roots blower comprises two rotary vanes configured to mesh with each other upon rotation. Each rotary vane is arranged on an individual axle, wherein the individual axles are connected to each other via gears so that the axles may be driven synchronously by a single drive unit. Each of the rotary vanes may according to this disclosure be considered as being a pressure boosting unit 32. The Roots compressor may thus be considered comprising a drive unit 31, and a first and a second pressure boosting unit 32A, 32B. In the example pressure control devices 30; 30A, 30B shown in FIG. 2, the first pressure boosting unit 32A and the second pressure boosting unit 32B are driven by the drive unit 31 via a common shaft 33.

Although the subsets of ADU are preferably arranged pairwise symmetrically, the distances from outlets 35A and 35B to their respective subsets of ADUs may not be the same. Often, the pressure control devices 30 are not positioned symmetrically or the air pipes to one side of the hull may run along paths of different lengths. This would mean a different flow and/or different pressure losses in the feeding from the one or more pressure control devices 30 to subsets 20AB and 20BA or 20CD and 20DC. Such differences may be compensated by the first pressure boosting unit 32A and the second pressure boosting unit 32B having different capacities or efficiencies with respect to their size and shape, so that the pressure boosting unit 32 connected to the one feeding the line with the higher losses has a higher capacity or efficiency, resulting in the symmetrically arranged ADU subsets being fed with the same flow also when the pressure boosting units 32A and 32B are driven via a common shaft 33.

In one or more example air supply systems 100, the inlet air flow may be ambient air, such as air at atmospheric pressure. The ambient air is then fed to the first pressure control device 30A and the second pressure control device 30B, where the air may be compressed to a pressure larger than the discharge pressure at the ADUs 20; 20AB, 20BA; 20CD, 20DC. The compressed air is then supplied to the ADUs 20; 20AB, 20BA; 20CD, 20DC via the first and the second opening 35A, 35B of the first and the second pressure control device 30A, 30B.

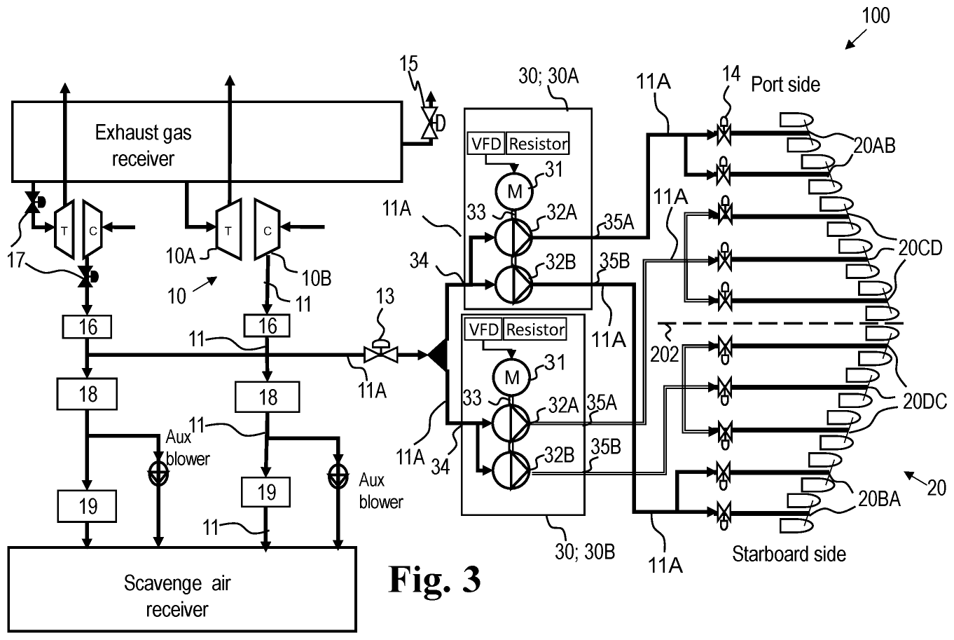

FIG. 3 illustrates an air supply system according to some examples herein. In the air supply system 100 shown in FIG. 3, the inlet air flow is a compressed scavenging air flow from an engine of the vessel. The example air supply system 100 shown in FIG. 3 comprises one or more turbochargers 10. Each turbocharger 10 comprises a turbine 10A driven by an exhaust gas flow from the engine (not shown in FIG. 3) of the vessel. The turbine may comprise a turbine housing and a turbine wheel rotatably arranged in a turbine housing. The turbine wheel may be forced to rotate by an exhaust gas flow through the turbine housing. The exhaust gas flow may be received from an exhaust gas receiver of the engine. The exhaust gas receiver may receive exhaust gases produced during a combustion process from the engine. Each turbocharger 10 further comprises a compressor 10B for supplying the compressed scavenging air flow to the engine, such as to a scavenging air receiver of the engine, via the first flow path 11A. The compressor may comprise a compressor housing and a compressor wheel, which may also be referred to as an impeller, rotatably arranged within the compressor housing. The compressor wheel may be rigidly connected to the turbine wheel so that the turbine wheel drives the compressor wheel. The compressor receives air which is then compressed by the rotation of the compressor wheel. The compressed air from the compressor of the turbocharger, which compressed air may also be referred to as scavenging air, may then be fed to the engine, such as to the scavenging air receiver of the engine via a scavenging air flow path 11.

The scavenging flow path 11 may comprise an air cooler 16 for cooling the compressed air from the compressor of each turbocharger 10, a water mist catcher 18 for removing moisture from the compressed air flow, and/or a non-return valve 19 for preventing air to flow from the scavenging air receiver into the scavenging air flow path 11. The water mist catcher 18 may be arranged downstream of the air cooler 16. The non-return valve 19 may be arranged downstream of the water mist catcher 18. In the example air supply system shown in FIG. 3, the first flow path 11A is connected to the scavenging air flow 11 for extracting the scavenging air flow. The first flow path 11A may be connected to the scavenging air flow path 11 between the air cooler 16 and the water mist catcher 18.

Extracting the scavenging air downstream the air cooler has the benefit that the extracted scavenging air is cooled. Cooling the air reduces risk of corrosion in the air supply system, which reduces the required maintenance of the system. Cooling the air further allows a higher density flow, which increases the energy efficiency of the system. Extracting the scavenging air upstream the water mist catcher 18 prevents contaminated gases from the combustion process to leak into the first flow path 11A. Thus, only non-contaminated, such as clean, air is provided to the outside of the hull of the vessel, which may reduce the environmental impact of the air supply system. The air supply system 100 may comprise a changeover valve 13 arranged in the first flow path 11A for opening and/or closing the first flow path 11A, to allow or prevent a flow of air, such as scavenging air through the first flow path 11A.

The pressure of the compressed air flow may be dependent on the load of the engine. At low loads the exhaust gas flow may be low which will cause the turbine of the turbocharger, which is driven by the exhaust gas flow, to rotate at low revolutions per minute (rpm). Consequently, the compressor will rotate at the same rpm and will not provide its maximum compression performance. At low engine loads, the scavenging pressure may thus be below the discharge pressure at the ADUs 20. The scavenging air may thus be fed to the one or more pressure control devices 30, where the pressure of the scavenging air flow is boosted, such as increased, to a pressure larger than the discharge pressure at the ADUs 20. The scavenging air flow having a pressure larger than the discharge pressure at the ADUs 20 is then fed to the ADUs 20 where it is discharged to the outside of the hull of the vessel. Using scavenging air flow as the inlet air flow has the benefit that the inlet air flow has already been compressed, such as pre-compressed, by the one or more turbochargers 10. The pressure control means 30 thus has to perform less compression work compared to the example system disclosed in FIG. 1, where the inlet air flow is ambient air.

Upon the pressure of the compressed air flow upstream of the pressure control device 30 exceeding the discharge pressure at the ADUs 20, such as at higher engine loads where the pressure of the scavenging air is larger than the discharge pressure, the first pressure boosting unit 32A and/or the second pressure boosting unit 32B may be configured to reduce the air flow through the first flow path 11A. When the pressure boosting units are fixed volume displacement, such as fixed flow, units, such as blowers or compressors, the flow through the pressure boosting unit is set based on the rpm of the pressure increasing unit. Hence, if the inlet flow to the pressure boosting unit is higher than the fixed volume displacement at the current rpm of the pressure boosting unit 32A, 32B, then the flow will be reduced to the fixed volume displacement of the pressure boosting unit 32A, 32B. The first pressure boosting unit 32A and/or the second pressure boosting unit 32B may e.g. windmill in the air flow through the first flow path 11A. The first pressure boosting unit 32A and/or the second pressure boosting unit 32B may thus act as restrictors in the first flow path 11A.

In one or more example air supply systems 100, the air supply system may further comprise one or more cut-out valves 17 for turning on or off a gas flow to a turbine side and/or from a compressor side of at least one of the two or more turbochargers 10. The example air supply system shown in FIG. 3 comprises two turbochargers 10 wherein one of the two turbochargers 10 comprises cut-out valves 17. The air supply system may however comprise more than two turbochargers 10, such as three, four, five or six turbochargers 10, wherein at least a subset of the turbochargers 10 is provided with cut-out valves 17. The cut-out valves 17 may be configured to be fully opened or fully closed or may be configured to be gradually controlled between an open and closed position. The sub-flow path 11A may be connected to the respective main flow path 11 of each of the one or more turbochargers 10. The air supply system may further comprise an exhaust gas bypass (EGB) valve 15. In case the turbochargers 10 risk overspeeding, the EGB valve may be opened to release some of the exhaust gas flow, which will reduce the amount of exhaust gas driving the turbochargers 10. The speed of the turbochargers 10 may thus be reduced. The one or more turbochargers 10 are typically configured to provide a maximum allowable scavenging air pressure to the engine. The maximum allowable scavenging air pressure may be determined based on an engine pressure ratio and a pressure rise during combustion. The maximum scavenging pressure may be selected so that the scavenging pressure provided does not overload the engine. However, when adding or opening the bypass, such as the sub-flow path, so that a sub-flow of air is extracted from the main flow path 11, the scavenging air pressure will decrease with the increased flow in the bypass. The reason for this is that the amount of air, and thus the energy, circulated through the engine and provided to the one or more turbocharger(s) reduces.

In some example air supply systems 100 herein, the drive unit 31 may, upon the pressure of the compressed air flow upstream of the pressure control device 30 exceeding the discharge pressure at the ADUs 20, be configured to be driven by the first pressure boosting unit 32A and/or the second pressure boosting unit 32B and to remove energy from the flow of air. When the drive unit 31 is an electric motor, the electric motor may be configured to, upon the pressure of the compressed air flow upstream of the pressure control device 30 exceeding the discharge pressure at the ADUs 20, be driven by the first pressure boosting unit 32A and/or the second pressure boosting unit 32B and to act as a generator of electrical energy. The electrical energy generated may be fed to an electrical system of the vessel or to an energy storage. The first and second pressure boosting units may comprise a flow reduction device for restricting the flow through the first flow path 11A. The flow reduction device may act as a brake for the air supply system, causing a control and restriction of the flow through the first flow path. The flow reduction device may for example be a resistor causing a resistance in the electrical system and/or a Variable Frequency Drive (VFD) for controlling the electric motor. The flow reduction may be used to ensure that a sufficient amount of compressed air is available at the engine of the vessel.

In one or more example air supply systems 100, the air supply system 100 may comprise a flow control device 12 arranged in the first flow path 11A for controlling the flow through the first flow path 11A. The flow control device 12 may be a fixed orifice allowing a fixed flow through the first flow path 11A, or a variable orifice, such as a control valve, for allowing a variable flow of air through the first flow path 11A.

In one or more example air supply systems 100, the air supply system 100 may comprise one or more non-return valves 14 arranged in the first flow path 11A between the one or more pressure control device(s) 30 and the ADUs 20 for preventing sea water from entering the first flow path 11A through the ADUs 20.

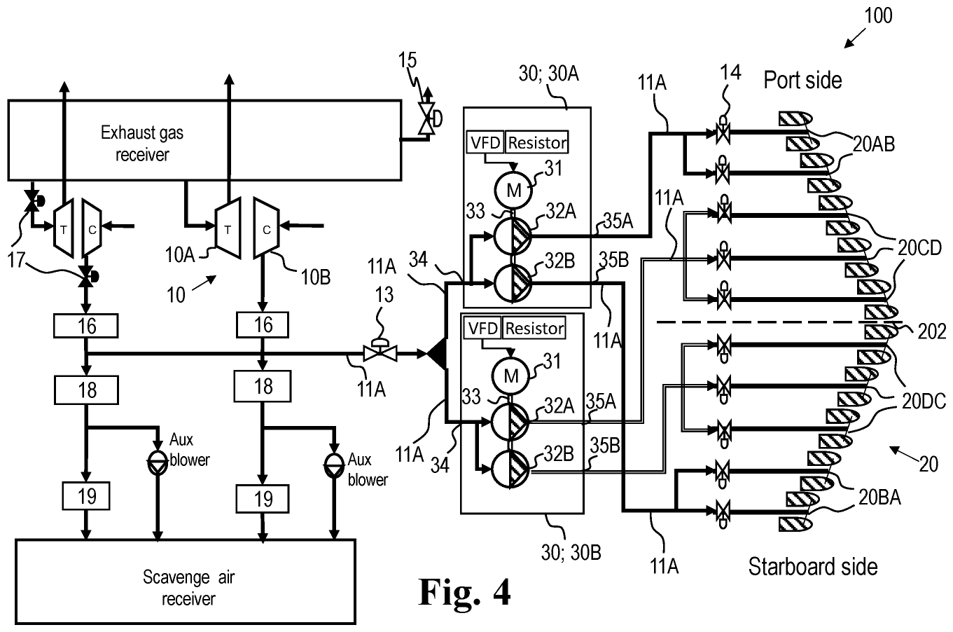

FIG. 4 shows an example air supply system 100 according to this disclosure when the vessel is at steady state, such as when the vessel is level in the water. When the vessel is level in the water, the discharge pressure may be the same in all of the ADUs. The one or more pressure control device(s) 30 may thus provide a fixed volume flow of air with the same pressure to each the plurality of ADUs 20, via the outlets 32A, 32B, as indicated by the diagonal lines of the ADUs 20.

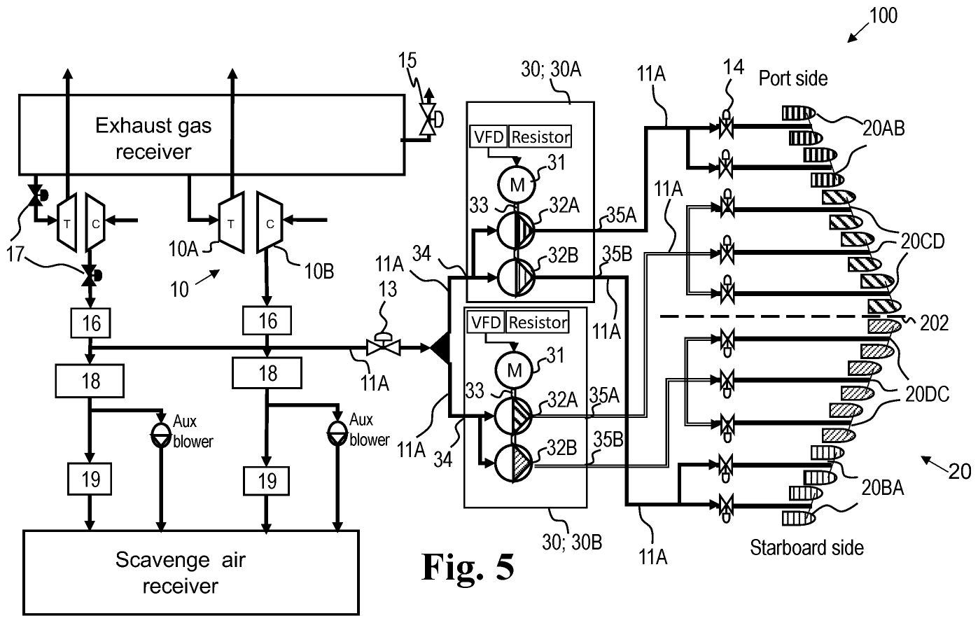

FIG. 5 shows an example air supply system 100 according to this disclosure when the vessel is rolling, such as when the vessel rotates around its longitudinal centreline and is located at an inclination angle to the water surface. When the vessel is rolling, the discharge pressure may vary over the ADUs 20AB, 20BA; 20CD, 20DC. The discharge pressure may vary over the ADUs 20AB, 20BA; 20CD, 20DC depending on how deep the ADUs 20AB, 20BA; 20CD, 20DC are submerged in the water surrounding the vessel. The ADUs 20AB, 20BA; 20CD, 20DC arranged on the opposite side to which the vessel is rolling towards, such as the starboard side when the vessel is rolling towards the port side, will be submerged less deep into the water than the ADUs on the opposite side, such as on the port side of the vessel. The discharge pressure at the ADUs 20 may comprise a static part P and a dynamic part dP. The discharge pressure for an ADU 20AB; 20CD arranged on the port side (PS) may thus be P+dP(PS). For opposite ADUs 20BA; 20DC located at the same distance to the rotation axis on the starboard (SB) side of the vessel, such as to the longitudinal centreline of the vessel, the pressure may be P+dP(SB). In this case, where the ADUs 20AB and the ADUs 20BA, or the ADUs 20CD and the ADUs 20DC, are located at the same distance from the longitudinal centreline of the vessel, the dynamic pressure at the port side may increase with the same amount as the dynamic pressure decreases at the starboard side, such that dP(SB)=−dP(PS). The two ADUs, such as the port side ADU 20AB and the starboard side 20BA, will together experience a constant power requirement equivalent to the pressure P. Hence the differential pressure may be balanced by the work made by the one or more pressure boosting unit(s) 32, such as the first pressure boosting unit 32A connected to the ADUs 20AB; 20CD and the second pressure boosting unit 32B connected to the ADDs 20BA; 20DC, of the one or more pressure control device(s) 30 being coupled by the common shaft 33. The discharge pressure, such as the water pressure, acting on the ADDs 20BA; 20DC on the starboard side will thus be lower than the water pressure acting on the ADDs 20AB; 20CD arranged on the port side. The one or more pressure control device(s) 30 may provide a fixed volume flow of air to each of the plurality of ADDs 20; 20AB, 20BA; 20CD, 20DC, however the pressure provided through the outlet 32A connected to ADDs 20AB; 20CD arranged on the port side of the vessel will provide a higher pressure to each the plurality of ADDs 20AB; 20CD, than the pressure provide by the second outlet 32B connected to the starboard side ADDs 20BA; 20DC. When the discharge pressure in one or more of the ADDs 20AB; 20CD arranged on the port side increases, the pressure required at the first pressure boosting unit 32A to provide the fixed volume flow increases. This will increase the power requirement on the drive unit 31 from the first pressure boosting unit 32A. However, since the discharge pressure at the starboard side ADDs 20BA; 20DC will decrease with the same amount, so will the power requirement on the drive unit 31 from the second boosting unit 32B. The drive unit will thus not experience any net changes, or at least not any substantial net changes, in power demand from the first and the second pressure boosting units 32A, 32B. Hence, the one or more pressure control devices 30 will passively adapt the pressure at the first outlet 35A and the second outlet 35B, such as at the first pressure boosting unit 32A and the second pressure boosting unit 32B, passively. The higher pressure is indicated by the thicker lines of the pattern in the ADDs 20AB; 20CD. The second pressure control device 30B that is connected to the ADDs 20CD; 20DC mounted closer to the centreline 202 if the vessel will provide a lower pressure to the ADDs at constant flow, since the pressure difference between the port and the starboard side ADDs 20CD, 20DC will be less than for the ADDs 20AB, 20BA mounted further away from the centreline 202, such as at a transverse position further away from the centreline 202 of the vessel, and thus will experience less vertical movement than the ADDs 20AB, 20BA. Thereby, the pressure difference due to the difference in water level acting on the ADDs on either side of the longitudinal centreline will also be less.

It shall be noted that the features mentioned in the embodiments described in FIGS. 2-5 are not restricted to these specific embodiments. Any features relating to the air supply system and the components comprised therein and mentioned in relation to the air supply system using ambient air of FIG. 2, are thus also applicable to the air supply system using scavenging air described in relation to FIGS. 3-5. Correspondingly, any features relating to the air supply system and the components comprised therein and mentioned in relation to the air supply system using scavenging air of FIGS. 3-5, such as the controlling of the pressure of the air flow to the ADDs, are thus also applicable to the air supply system using ambient air described in relation to FIG. 2.

It shall further be noted that a vertical axis, when referred to herein, relates to an imaginary line running vertically through the ship and through its centre of gravity, a transverse axis or lateral axis is an imaginary line running horizontally across the ship and through the centre of gravity and a longitudinal axis is an imaginary line running horizontally through the length of the ship through its centre of gravity and parallel to a waterline. Similarly, when referred to herein, a vertical plane relates to an imaginary plane running vertically through the width of the ship, a transverse plane or lateral plane is an imaginary plane running horizontally across the ship and a longitudinal plane is an imaginary plane running vertically through the length of the ship.

Embodiments of products (air supply system and vessel) according to the disclosure are set out in the following items:
Item 1. An air supply system (100) for supplying air to an outside of a hull of a vessel, the air supply system (100) comprising:
   a plurality of air discharge units, ADDs, (20; 20AB, 20BA) for releasing a compressed air flow to an outside of the hull below a waterline of the vessel, wherein the plurality of ADDs (20; 20AB, 20BA) are configured to be symmetrically arranged around a longitudinal centreline (202) of the hull of the vessel,
   a first flow path (11A) for providing the compressed air flow to the ADDs (20),
   one or more pressure control device(s) (30) arranged in the first flow path (11A) for feeding the compressed air flow to the ADDs (20) at pressure larger than a discharge pressure at the ADDs (20; 20AB, 20BA), wherein each pressure control device (30) comprises an inlet (34) for receiving an inlet air flow, a first outlet (35A) and a second outlet (35B) for feeding the air flow to a subset of the plurality of ADDs (20; 20AB, 20BA), wherein the first outlet (35A) is connected to a first subset of ADDs (20AB) arranged on a first side of the longitudinal centreline (202) of the hull (201) of the vessel (200) and the second outlet (35B) is connected to a second subset of ADDs (20BA) arranged on a second, opposite, side of the longitudinal centreline (202) of the hull of the vessel, wherein the one or more pressure control device(s) (30) is/are configured to compensate for a difference in discharge pressure between the first subset of ADUs (20AB; 20CD) and the second subset of ADUs (20BA; 20DC).
Item 2. The air supply system (100) according to Item 1, wherein the first subset of ADUs (20AB) are arranged at a same distance from the longitudinal centreline (202) of the vessel as the second subset of ADUs (20BA).
Item 3. The air supply system (100) according to any one of the previous Items, wherein each pressure control device (30) comprises a drive unit (31), a first pressure boosting unit (32A) for feeding compressed air to the first outlet and/or a second pressure boosting unit (32B) for feeding compressed air to the second outlet, wherein the first pressure boosting unit (32A) and the second pressure boosting unit (32B) are driven by the same drive unit (31).
Item 4. The air supply system (100) according to Item 3, wherein the first pressure boosting unit (32A) and/or the second pressure boosting unit (32B) is a blower or a compressor.
Item 5. The air supply system (100) according to Item 3 or 4, wherein the first pressure boosting unit (32A) and the second pressure boosting unit (32B) is a fixed volume displacement blower or compressor.
Item 6. The air supply system (100) according to any one of the Items 3 to 5, wherein the drive unit (31) is an electric motor.
Item 7. The air supply system (100) according to any one of Items 3 to 6, wherein, upon the pressure of the compressed air flow upstream of the pressure control device (30) exceeding the discharge pressure at the ADUs (20), the first pressure boosting unit (32A) and/or the second pressure boosting unit (32B) are configured to reduce the flow through the first flow path (11A).
Item 8. The air supply system (100) according to any one of Items 3 to 7, wherein, upon the pressure of the compressed air flow upstream of the pressure boosting (30) exceeding the discharge pressure at the ADUs (20), the drive unit (31) is configured to be driven by the first pressure boosting unit (32A) and/or the second pressure boosting unit (32B) and to remove energy from the flow of air.
Item 9. The air supply system (100) according to any one of Items 3 to 8, wherein the drive unit (31) is an electric motor and, upon the pressure of the compressed air flow upstream of the pressure boosting (30) exceeding the discharge pressure at the ADUs (20), the electric motor (31) is configured to be driven by the first pressure boosting unit (32A) and/or the second pressure boosting unit (32B) and to act as a generator of electrical energy.
Item 10. The air supply system (100) according to any one of the previous Items, wherein the inlet air flow is ambient air.
Item 11. The air supply system (100) according to any one of the Items 1 to 10, wherein the inlet air flow is a compressed scavenging air flow from an engine of the vessel.
Item 12. The air supply system (100) according to Item 11, wherein the air supply system (100) comprises one or more turbochargers (10), each turbocharger (10) comprising a turbine (10A) driven by an exhaust gas flow from the engine and a compressor (10B) for supplying the compressed scavenging air flow to the first flow path (11A).
Item 13. The air supply system (100) according to any one of the previous Items, wherein the air supply system (100) comprises a changeover valve (13) arranged in the first flow path (11A) for opening and/or closing the first flow path (11A).
Item 14. The air supply system (100) according to any one of the previous Items, wherein the air supply system (100) comprises a flow control device (12) arranged in the first flow path (11A) for controlling the flow through the first flow path (11A).
Item 15. The air supply system (100) according to any one of the previous Items, wherein the air supply system (100) comprises one or more non-return valves (14) arranged in the first flow path (11A) between the one or more pressure control device(s) (30) and the plurality of ADUs (20) for preventing sea water from entering the first flow path (11A) through the plurality of ADUs (20).
Item 16. The air supply system (100) according to any one of the previous claims, wherein the one or more pressure control device(s) (30) are fixed volume displacement pressure control devices providing a fixed volume flow of air to each of the plurality of ADUs (20).
Item 17. A vessel (200) comprising a hull (201), an engine and the air supply system (100) according to any one of the previous Items.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

What is claimed is:

1. An air supply system for supplying air to an outside of a hull of a vessel, the air supply system comprising:
a plurality of air discharge units, ADUs, for releasing a compressed air flow to the outside of the hull below a waterline of the vessel, wherein the plurality of ADUs are configured to be arranged around a longitudinal centreline of the hull of the vessel,
a first flow path for providing the compressed air flow to the ADUs,
one or more pressure control device(s) arranged in the first flow path for feeding the compressed air flow to the ADUs at pressure larger than a discharge pressure at the ADUs, wherein each pressure control device comprises an inlet for receiving an inlet air flow, a first outlet and a second outlet for feeding the air flow to a subset of the plurality of ADUs, wherein the first outlet is connected to a first subset of ADUs arranged on a first side of the longitudinal centreline of the hull of the vessel and the second outlet is connected to a second subset of ADUs arranged on a second, opposite, side of the longitudinal centreline of the hull of the vessel, wherein the one or more pressure control device(s) is/are configured to compensate for a difference in discharge pressure between the first subset of ADUs and the second subset of ADUs.

2. The air supply system according to claim 1, wherein the first subset of ADUs are arranged at a same distance from the longitudinal centreline of the vessel as the second subset of ADUs.

3. The air supply system according to claim 1, wherein each pressure control device comprises a drive unit, a first pressure boosting unit for feeding compressed air to the first outlet and/or a second pressure boosting unit for feeding compressed air to the second outlet, wherein the first pressure boosting unit and the second pressure boosting unit are driven by the same drive unit.

4. The air supply system according to claim 3, wherein the first pressure boosting unit and/or the second pressure boosting unit is a blower or a compressor.

5. The air supply system according to claim 3, wherein the first pressure boosting unit and the second pressure boosting unit is a fixed volume displacement blower or compressor.

6. The air supply system according to claim 3, wherein the drive unit is an electric motor.

7. The air supply system according to claim 3, wherein, upon the pressure of the compressed air flow upstream of the pressure control device exceeding the discharge pressure at the ADUs, the first pressure boosting unit and/or the second pressure boosting unit are configured to reduce the flow through the first flow path.

8. The air supply system according to claim 3, wherein, upon the pressure of the compressed air flow upstream of the pressure boosting exceeding the discharge pressure at the ADUs, the drive unit is configured to be driven by the first pressure boosting unit and/or the second pressure boosting unit and to remove energy from the flow of air.

9. The air supply system according to claim 3, wherein the drive unit is an electric motor and, upon the pressure of the compressed air flow upstream of the pressure boosting exceeding the discharge pressure at the ADUs, the electric motor is configured to be driven by the first pressure boosting unit and/or the second pressure boosting unit and to act as a generator of electrical energy.

10. The air supply system according to claim 1, wherein the inlet air flow is ambient air.

11. The air supply system according to claim 1, wherein the inlet air flow is a compressed scavenging air flow from an engine of the vessel.

12. The air supply system according to claim 11, wherein the air supply system comprises one or more turbochargers, each turbocharger comprising a turbine driven by an exhaust gas flow from the engine and a compressor for supplying the compressed scavenging air flow to the first flow path.

13. The air supply system according to claim 1, wherein the air supply system comprises a changeover valve arranged in the first flow path for opening and/or closing the first flow path.

14. The air supply system according to claim 1, wherein the air supply system comprises a flow control device arranged in the first flow path for controlling the flow through the first flow path.

15. The air supply system according to claim 1 wherein the air supply system comprises one or more non-return valves arranged in the first flow path between the one or more pressure control device(s) and the plurality of ADUs for preventing sea water from entering the first flow path through the plurality of ADUs.

16. The air supply system according to claim 1, wherein the one or more pressure control device(s) are fixed volume displacement pressure control devices providing a fixed volume flow of air to each of the plurality of ADUs.

17. A vessel comprising a hull, an engine and the air supply system according to claim 1.
